(19) United States
(12) Patent Application Publication
(10) Pub. No.: US 2007/0162759 A1
(43) Pub. Date: Jul. 12, 2007

(54) PROTECTED PORT FOR ELECTRONIC ACCESS TO AN EMBEDDED DEVICE

(75) Inventors: Ronald F. Buskey, Sleepy Hollow, IL (US); Barbara B. Frosik, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,348

(22) Filed: Dec. 28, 2005

(51) Int. Cl. H04L 9/32; H04L 9/00; G06K 9/00; H04K 1/00; G06F 17/30; G06F 7/04

(52) U.S. Cl. 713/182; 713/185; 713/168; 726/2

(57) ABSTRACT

A system and method for controlling access by a user to an embedded device. A protected access port, integral with the embedded device, includes an access manager and a level controller. The access manager issues a challenge phrase using a public key of the embedded device in response to a request by a user device to access the embedded device and determines the veracity of the user's response to the challenge phrase. A secure server stores a private key corresponding to the public encryption key of the embedded device and is operable to authenticate the user credentials and issues the response to the challenge phrase dependent upon the private key of the embedded device.

### BACKGROUND

Embedded devices such as integrated circuit processing devices provide multiple interfaces to outside entities. These interfaces make a variety of features available, such as testing, code and data transfer and access to memory. However, these interfaces can also be exploited for gaining unauthorized access to information stored contained within the device. By altering information used by the device, a user can obtain access to services which have not been paid for or which are confidential as well as the keys used to cryptographically protect information.

As the number of wireless and internet-connected devices increases, built-in protection becomes an important feature of the devices. Industry-wide, there is a continuing effort to define trusted computing platforms. One of the characteristics of trusted platform is a tamper-resistant interaction with the outside environment.

One of the interaction points between an integrated circuit and the external world is the JTAG port, which system designers typically provide for debugging purposes. A JTAG port is a port that conforms to a standard developed by the Joint Test Action Group and provides external test access to integrated circuits. The port uses a four- or five-pin external interface. The JTAG standard has been adopted as the standard IEEE 1149.

A JTAG port can be used to alter a device's memory, or retrieve sensitive information from the device. To prevent this, the port is often disabled in production devices. However, disabling the port prevents authorized users from making use of the port for future testing, modification or field evaluation of products.

The IEEE-1149 standard defines a mandatory set of public instructions that must be present in a JTAG-compliant implementation. This mandatory set includes the instructions IDCODE, BYPASS, EXTEST and INTEST. From this set only the INTEST instruction reveals or allows manipulation of the internal core-logic signals of the integrated circuit. For example, it is possible to re-program flash memory or alter unguarded secured information when the suitable data is supplied along with this instruction. The IDCODE instruction is used to retrieve the hard-wired identification number of the device. The BYPASS and EXTEST instructions are used for the boundary scan. In addition to the mandatory set, an optional or private set of instructions can be defined for a device.

Since the JTAG port gives access to the internal system components of the processor, there are a number of situations where protection of the JTAG port would be beneficial.

Other gateway interfaces to an embedded device would benefit from hardware protection, in similar manner as the JTAG port.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a diagram of a protected JTAG circuit and its external environment, consistent with certain embodiments.

FIG. 2 is a sequence diagram of a method of authorization of a protected JTAG circuit consistent with certain embodiments.

FIG. 3 is a state transition diagram of a method of operation of a protected JTAG circuit consistent with certain embodiments.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

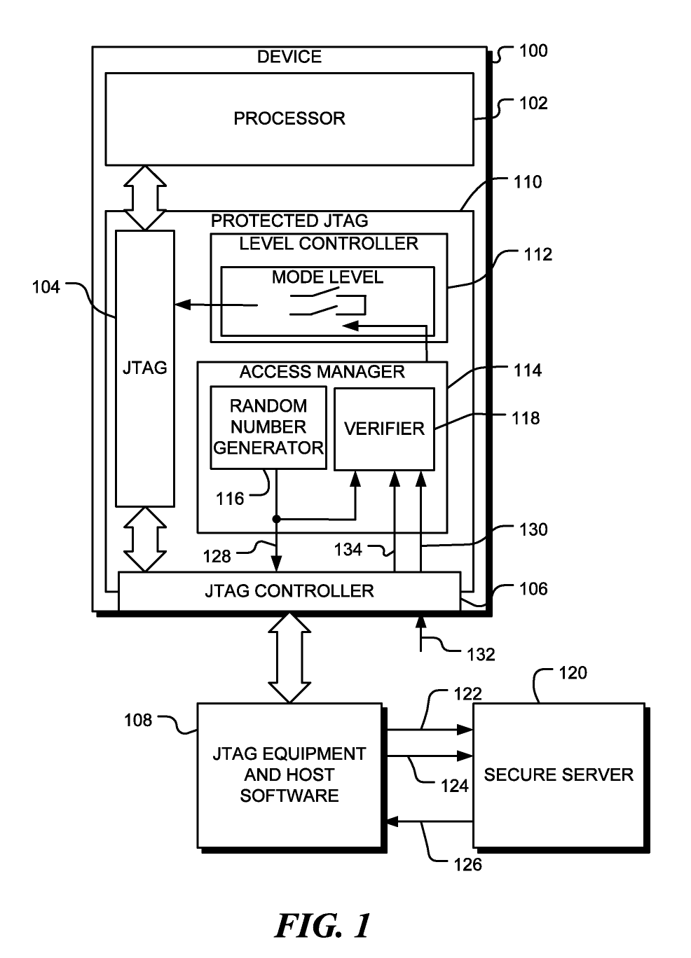

FIG. 1 is a diagram of a protected JTAG circuit and its outside environment, consistent with certain embodiments. Referring to FIG. 1, a device 100 includes a processor 102, a JTAG port 104, and a JTAG controller 106. The JTAG controller 106 interfaces with JTAG equipment 108. The JTAG port 104 is part of a protected JTAG circuit block 110 that controls access to the processor 102. The protected JTAG block allows only a selected group of users to access functions for viewing or altering internals of the processor. Fewer or no restrictions are placed on JTAG debugging functions that are used in the detection of circuit continuity, since this type of JTAG access does not give the user access to private and confidential information. The protected JTAG port, in addition to the standard JTAG functionality, provides a discrimination mechanism imposing different levels of access to the processor.

The protected JTAG block 110 includes a level controller 112 and an access manager 114. The access manager 114 includes a random number generator 116 and a verifier module 118. The operation of these elements is discussed below.

The required supporting infrastructure and tools include a Secure Server 120 and a protected JTAG Manager, which works with the debugging tools on the host JTAG equipment 108. The protected JTAG block 110 (also referred hereafter simply as a protected JTAG) provides authentication functions and access mode control for each supported level of access defined for the processor 100. In addition, the processor is configured to accept enhanced JTAG signaling. The access restrictions are handled by additional hardware blocks within the protected JTAG 110: Level Controller 112 and Access Manager 114. These combine to set the access mode for the protected JTAG.

JTAG Access Modes.

In one embodiment, the Protected JTAG 110 is configurable to allow a number of different access modes, corresponding to different levels of protection. Embedded devices provide various types of service. Some products do not need security measures, and it is appropriate to grant non-restricted JTAG access to these devices by all users. An example could be a complex electronic toy, or home equipment controller. The demand for a protected JTAG materializes in products that have trusted computing requirements. Examples include cellular telephones, PDAs, media devices and automotive controllers.

In addition to a variety of products imposing different protection requirements, different points in the product life cycle require different access levels. Any new device goes through different phases during its lifetime. After the device is designed, it has to be developed, tested, assembled, and built into a product. A product's required protection varies during these phases.

A Protected JTAG 110 provides different levels of protection. The fully protected level limits user access through the JTAG port to external functions such as test of chip circuitry and board level interconnections. Optionally, non-intrusive internal component testing can be allowed. This optional component testing feature should not reveal any private information and not allow write to the memory or processor's registers. Implementation of this feature may be architecture specific. The middle protection level allows programming flash memory and reading and writing to registers and memory, except from within the secure area. The lowest protection level does not offer any protection and allows full access including unlimited access to the secure area.

A Protected JTAG 110 provides the means for granting appropriate access by providing a tamper-resistant state selection capability. The states determined by hardware configuration correspond to access modes. Once the mode is set, it is possible to change it to a new mode of greater protection, but not to a mode that provides lower protection. In one embodiment, the access modes are derived from a set of fuses. The fuse technology must be such that the fuses are set irreversibly. Burning a set of fuses determines a security level. Burning more fuses increases the level. Thus the security level can be only increased.

Each of the access modes has a default protection level. Once the access mode is established, the level of protection can be temporarily lowered by authorized users only. The diagram in FIG. 1 illustrates the Level Controller block 112 that derives access level from protection state selection and the Verifier module 118.

The table below summarizes the protected JTAG applicability and access levels to all and authorized users, in each access mode, for one embodiment. The access modes are described in more detail below.

TABLE 1
Access Modes

| | | | Allowed Access |
|---|---|---|---|
| Protected JTAG | | Allowed Access | to authorized |
| access mode | Applicability | to all users | User |
| Non Protected | Devices with no | Full JTAG access, | same as to non |
| | protection built in | internal and external | authorized users |
| | Debug and evaluate devices | functions enabled, | |
| | in development phase | additionally the | |
| | Field returns | security mechanism is | |
| | Factory test | unrestricted | |
| Low Protection | Debug and evaluate device | Full access to JTAG | The authorized user can |
| | in development phase | internal and external | lower protection to the |
| | Configure devices shipped | functions, except secure | lowest level |
| | out | area. The security | |
| | Field returns | designated mechanism is | |
| | | enabled to prevent access | |
| | | to the secure area. | |
| High Protection | Devices at customer | Access limited to external | Two levels of access |
| | | functions such as test of | determined by user's |
| | | chip circuitry and board | credentials. User can |
| | | level interconnections. | lower protection to two |
| | | Optionally a non-intrusive | lower levels. |
| | | internal component testing | |
| | | can be allowed | |
| High Gated | Devices at customer | The same access as in | Two levels of access |
| Protection | | the High Protection mode | Approval must be granted |
| (optional) | | | for each restricted JTAG |
| | | | command |
| Maximum | Devices at customer | Access limited to external | Not Applicable |
| Protection | | functions such as test of | |
| | | chip circuitry and board | |
| | | level interconnections. | |
| | | Optionally a non-intrusive | |
| | | internal component testing | |
| | | can be allowed | |

Lowering Protection Level in Low and Non Protected Access Mode. The JTAG port 104 (FIG. 1) in a non-protected access mode allows full access to the device, including viewing and altering the otherwise protected area. These capabilities are deemed necessary during the product's development phase. Additionally an engineer debugging the product either during the development stage or for field returns would benefit from such capability. However these rights need to be given in a very restrictive manner (i.e. only to trusted users).

Furthermore, products without built-in security (i.e., without protected data) do not need any protection. It is appropriate to grant full access to such products through the JTAG port.

Low Protection Access Mode. In the Low Protection Access mode, the user is still able to view protected data through JTAG port, as well as write to the flash memory. However in this mode the secure information such as private keys or secret data are tamper resistant but not necessarily hidden. The restrictions would be imposed by architecture dependent security mechanism. For the reason that the user is capable of assembling confidential or private data, this access is given only to trusted users. This mode can be used during the development phase, when the secure area has been successfully verified. Additionally this mode can be sufficient to restore field returns, for example to re-flash memory.

In some cases it may be necessary to open the security mechanism. It is possible to reduce the protection level temporarily to the unprotected level. This capability can be used by a restricted group of trusted users, who have the strongest credentials.

High Protection Access Mode. To prevent the user from accessing secured memory (protected data), the product delivered to the customer should not provide any access to secure data through the JTAG port 104 (FIG. 1). For this reason the user can use only JTAG instructions that do not reveal contents of the secured memory. The user can perform boundary tests using the BYPASS, PRELOAD or EXTEST standard instructions, retrieve the device ID with the IDCODE instruction, and do component testing with the RUNBIST instruction.

In some applications the boundary test or component test can be more complex and require more intrusive methods. The INTEST or SAMPLE standard instructions or other private instructions can be used for this purpose. However, these instructions should not reveal the contents of the secure memory and should not allow write access to the processor memory.

A product configured with the low or high protection access mode can have the protection level reduced temporarily, if requested by a trusted user. From low protection mode the level can go down to Non Protected, where from high protection mode the protection level can go down to Low Protection or Non Protected levels, depending on the user's credentials. This feature of protected JTAG is intended for debugging functions on field returns.

High Gated Protection Access Mode. This access mode provides all the features of high access mode. The difference is an additional exit event that is accepted to terminate the lowered protection JTAG session. In this mode, the protection is restored back to the default by the device after each JTAG instruction. This feature could be added to ensure the device will not be left compromised in case of the human error after successful certification and testing session. However this mode would be implemented selectively. The implementation of this feature is rather complex and devices that would not use it may not implement it at all. The complexity results from the requirement of detecting the end of each JTAG instruction. This implies additional logic within JTAG. The condition would be then passed to the Level Controller block.

Maximum Protection Access Mode. JTAG access in maximum protection mode is the same as in the high protection access mode. The difference between the two is the option of temporarily downgrading the protection level in the high protection access mode. This capability is not supported in the maximum protection access mode.

This mode is intended for the products delivered to the customer that contain very sensitive information. In this case, the protected data is not meant to be accessed via JTAG under any conditions by anyone.

Other products that could adopt this type of protection could be inexpensive devices, where it is more economical to replace the device than it is to repair it.

Protected JTAG Authorization.

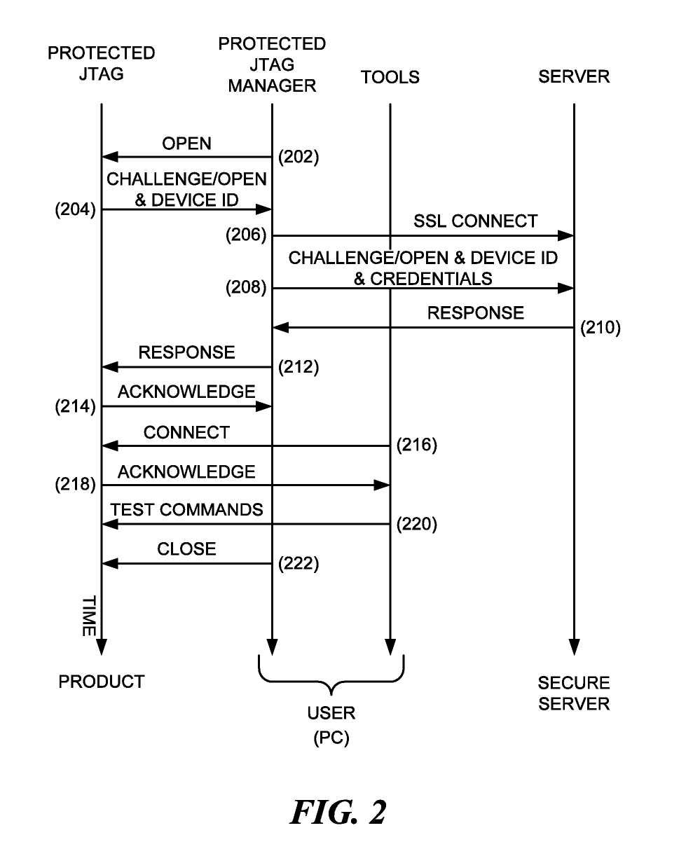

In one embodiment, the protected JTAG authorization process is based on challenge-response identification algorithm. A designated secure server (120 in FIG. 1) is used to complete the authentication process. The secure server's role is to generate responses to given challenges. FIG. 2 is a sequence diagram of a method of authentication of a protected JTAG circuit consistent with certain embodiments. The sequence involves communication between a protected JTAG on a target device or product, a protected JTAG Manager and other software tools on a user's computer 108, and a secure server.

Referring to FIG. 2, the first step (202) of the sequence is the OPEN request initiated by the user to the protected JTAG. It is necessary for the user to obtain tools that manage communications between the protected JTAG, the user, the user's computer 108, and the secure server. The OPEN command is represented by a bit sequence which indicates both the request to downgrade protection as well as the targeted protection level. The OPEN request starts an authentication process. Upon receiving the command, the Access Manager (114 in FIG. 1) composes a message from a random number and the requested protection level information and encodes it into the challenge phrase. Thus, the challenge phrase includes a cipher of the random number combined with request sequence.

The random number is generated by the random number generator part of the Access Manager (116 in FIG. 1). The required protection level information is represented by a bit sequence of the OPEN command. By combining the OPEN bit sequence with the random challenge, the system can discriminate between levels of certification and use the same key.

Referring again to FIG. 2, the challenge phrase is retained by the Access Manager and passed to the JTAG Manager as the next step (204) of a hand-shake scheme to the OPEN request. Along with the challenge, the device sends its ID, by which the secure server determines which key to use to generate response. One key can be associated with several devices, depending on the key distribution scheme.

At (206) the JTAG Manager opens a connection, such as a secure socket layer connection, with the secure server. At (208) the JTAG Manager passes the challenge phrase, device's ID along with the host's and user's computer credentials to the secure server (120 in FIG. 1) through the connection. The secure server verifies user's credentials. Only when the user is authorized to obtain the requested protection level, can the server grant it. The verification process starts with decrypting of the challenge phrase and retrieving level being requested. If the user's credentials match the level requested then verification is successful and the user is authorized. Upon successful authorization the secure server, at (210), retrieves the random number part of the decrypted challenge and sends back a verification token that includes the random number. Upon reception of the response, the JTAG Manager passes it to the protected JTAG at (212).

The response phrase is then verified by the Verifier block within the Access Manager module, by comparing the response with the original random information that was generated as part of the challenge. If successful, the response phase is acknowledged at (214) and the requested level of access is enabled until the device next power down or detection of CLOSE bit sequence. A device configured to the High Gated protection mode would additionally return to the default protection level at the end of each JTAG instruction. Once access is enabled, the user tools may connect to the protected JTAG at (216). This connection is acknowledged at (218) and test commands can be issued at (220) to interface with the device via the protected JTAG until device power down or a CLOSE bit sequence is issued by the JTAG Manager at (222).

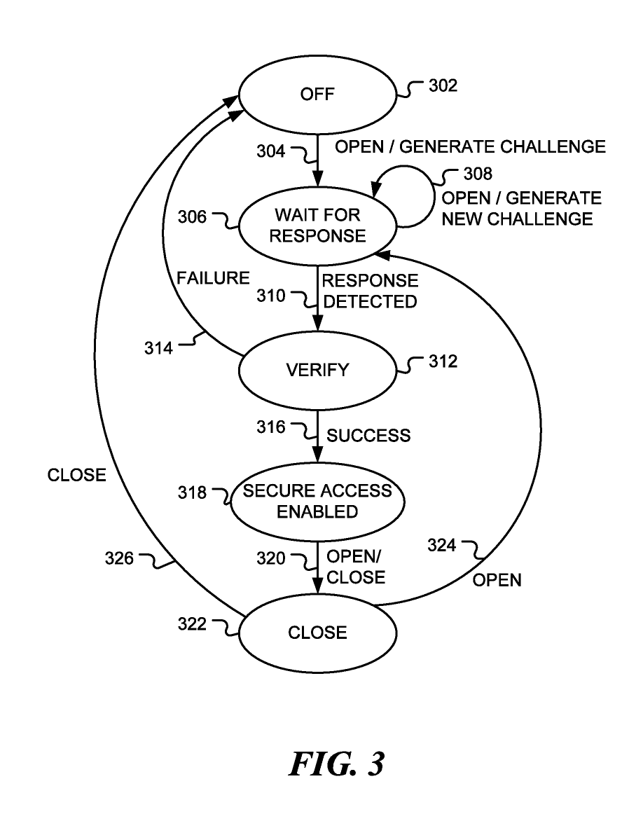

The state transition diagram in FIG. 3 (discussed below) shows the states, events and actions of the Access Manager module of the protected JTAG.

The authorization scheme presented here relies on generation of the challenge and response pair for each access. This “per access” authorization scheme rules out the possibility of an unauthorized user using old bit sequences in the future in a replay attack.

The Access Manager module of the protected JTAG is implemented in hardware in such a way as to allow the authorization process to run independently from the processor. The hardware solution guarantees a reliable authorization even if the processor's software has been tampered with or the processor hardware is the cause of the problem that is being evaluated. Several advantages of hardware JTAG implementation in the trusted platform environment can be listed. For one, the JTAG port can be used by an authorized user to debug the main processor's boot sequence when the trusted boot failed and debugging is required on field returns. It can also be used to debug the running system when the tamper attempt or other failure was detected. In order to enable the JTAG port to debug the boot sequence, the JTAG public key has to be part of the JTAG hardware, separated from the main processor, in tamper-resistant memory.

FIG. 1 shows the hardware blocks that are the major components of the Access Manager. The role of the Random Number Generator module (RNG) 116 is to generate random numbers for the challenge phrase for each OPEN sequence recognized as an authorization request and for use in encrypting messages to the server. In one embodiment, this module derives the random number from the device's entropy captured at the current time. More complex is the Verifier module 118, whose function may require numerous clock cycles. The clock 130 can be implemented within the Protected JTAG 110, or can be supplied by the JTAG connection as an incoming signal 132. In this latter setting, the Verifier module 118 must be insensitive to the fluctuation of the clock cycle. The Verifier module 118 sends the challenge 128 and receives the response 134 from the secure server to the challenge/open request (element 212 in FIG. 2).

Hardware Implications.

Protected JTAG. As shown in FIG. 1, the protected JTAG 110 comprises the Level Controller block 112 and the Access Manager block 114 in addition to the JTAG port 104. The design of the Random Number Generator module 116 and Verifier module 118 within the Access Manager should be optimized primarily for size and secondarily for the number of cycles. Additionally the Access Manager 114 includes logic to execute the state machine, as described in a previous section.

The Level Controller 112 is configured to provide the tamper resistant, irreversible state selection solution corresponding to access modes. In the example shown in FIG. 1, 2 fusible links are shown blown open. Other equally non-reversible means could be used. It should also include logic to accept inputs from the Access Manager block 114.

The signals exchanged between the protected JTAG blocks themselves and between the processor 102 should also be tamper proof and hidden in the internal silicon layer. The signals indicating protection level will be applied in the internal JTAG and/or processor logic. The logic applying the signals inside the processor has to be architecture specific.

Secure Server. As mentioned before, a secure server 120 is provided to facilitate the authorization process (described above with reference to FIG. 2) that allows temporarily downgrade of the protection of the product through protected JTAG. The secure server 120 is loaded with the private keys associated with devices IDs and user credentials. The credential verification procedure implemented on the server grants the correct response to the challenge provided by the user thus the requested protection level will be granted by device to the user authorized to obtain this level.

In one embodiment, the user 108 and secure server 120 use a secure interface which allows communication of information, such as the challenge 122, credentials 124 and response 126, as a serial string.

Cryptographic Considerations

The secure server 120 (FIG. 1) is an important element in the protection scheme. In any event of compromising the private keys or the user data base, the device protection is compromised as well.

Verification of user credentials by the secure server is an important part of the whole scheme. A variety of verification methods are known to those of ordinary skill in the art.

Development and Test Tools.

The protected JTAG functions need development tools support. The tools should be capable of communicating with the Protected JTAG Access Manager module to pass the authorization related data to the secure server. The authorization process depicted in FIG. 2 shows the interactions that dictate the additional host tool support, such as the OPEN request, catching the challenge, communication with the secure server and passing back the response. These functions are required by the host tool, but are not required to be integrated into the tool itself. FIG. 2 shows the protected JTAG Manager module that handles these functions as separate from the test protocol part. The separation of functions within the host tools will carry out the testing compatibility.

The basic architecture and functionality of protected JTAG are disclosed above. Protected JTAG complements a trusted platform, offering important debugging features and yet protecting secure information. The core attributes of the solution presented here are the hardware implementation, diverse levels of access, and a highly secure mechanism based on the generation of challenge/response pair for each access. These attributes make the tool attractive for a wide variety of users and safe from a security perspective. The developers are able debug and test during the implementation phase. After the device is delivered to the customer, any repair shop can verify the circuit correctness but only users with credentials can debug the device deeper when this type of intervention is required.

The main objective of the Protected JTAG is to prohibit the JTAG access by all individuals that possibly could misuse the device. Yet, based on previous experience, JTAG can be a crucial point of access to the device. The flexibility of attaining protection and access through the JTAG port is achieved by the lowering protection access through authorization. The advantages are mostly noticeable when the device is in high protection access mode.

FIG. 3 is a state transition diagram for operation of an Access Manager 114 of a protected JTAG circuit consistent with certain embodiments. The initial state 302 is OFF. The Access Manager remains in this state until an OPEN bit sequence is detected, 304. Upon receiving the OPEN bit sequence, the Access Manager composes a message from a random number and the requested protection level information and encodes it into a challenge phrase. The random number is generated by the random number generator part of the Access Manager. The random number and OPEN sequence are retained by the Access Manager for this authorization session. The challenge is sent to the user computer 108 by the Access Manager 114. The Access Manager enters state 306, during which it waits for a response to the challenge. If a new OPEN sequence is detected, 308, the Access Manager discards the old challenge, generates a new challenge and sends the new challenge to the user. If a response sequence is detected, 310, the Access Manager enters a verification state 312, during which the response sequence is checked. If the verification fails, 314, (because an incorrect response sequence was received) the Access Manager returns to the OFF state 302. If the verification is successful, 316, the Access Manager enters state 318 during which access to the processor through the JTAG port is enabled. This state is retained until the device is powered down, a CLOSE bit sequence is detected, a new OPEN sequence is detected, or if the protected JTAG is opened in High Gate Protection Mode and the JTAG instruction is completed, 320. Following any of these events, the Access Manager enters a closing state 322, where the default access is restored, all resources cleared and registers set to initial values. The entry event to the closing state becomes an exit event. If a closing state was entered 324 by OPEN sequence, the Access Manager generates and issues a new challenge and returns to state 306 to wait for a response to the challenge. If, on the other hand, it was entered by a CLOSE bit sequence or if the protected JTAG is opened in High Gate Protection Mode and the JTAG instruction is completed, 326, the JTAG port is closed and the Access Manager returns to the OFF state, 302.

Examples of Use.

A couple of use cases are included below to illustrate the benefits of Protected JTAG.

Lower Access (low protection)—Loading Flash Memory. The owner of cell phone, Bob say, found an interesting game on web and downloaded it to his cellular telephone. After the download, his phone stopped working properly. First Bob tried to fix the problem himself. He found the “good” code on the internet and wanted to load the code to his phone device using the JTAG port. Note that several vendors provide hardware and software tools that can be used to re-flash the memory of a device. Bob connected the device through the JTAG port to the host PC using the hardware JTAG tool and ran the software tools on his host PC to download the code. Since the device was in high protection mode, it did not allow flash memory to be altered. The tools returned a general error message. In this instance the device was protected from loading unsecured code.

In order to recover the device, Bob had to bring the device to the provider shop. A trusted technician, Maverick say, is authorized to make the modifications in Bob's device. He had to lower the protection of the device to the low protection access through authorization process. He connected the device through the JTAG port to his host PC through the JTAG hardware tool. The software tools on the host PC contain the JTAG manager module. Maverick initiated the authorization procedure by invoking the OPEN command from the JTAG manager. At the time he also specified the type of OPEN as low protection access. JTAG manager sent the request to the Protected JTAG on the device. The protected JTAG answered with the challenge phrase. Upon receiving the challenge phase, the JTAG manager tool on host requested authorizing entry from Maverick. Maverick entered his credentials. The JTAG manager passed the challenge phrase and Maverick's credentials to the designated secure server. The secure server verified the credentials. After successful verification, the secure server generated response to the given challenge and sent it back to the JTAG manager. The JTAG manager passed the response to the Protected JTAG on the device and disconnected from the secure server. The protected JTAG verified the response. Upon successful verification the Protected JTAG granted the requested access to the device through the JTAG port. Maverick used the hardware JTAG connector and software tools on the host to initiate the re-flashing. The command completed successfully. After completion of the request, Maverick had to power down the device to restore the default access level.

Acquire Lowest Protection. Hackers extracted secure keys from the type of the phone that Bob has. The service provider offered Bob a key replacement. Bob brought his phone to the provider's shop. Maverick, the technician from the shop, runs the authorization procedure requesting non protected access. After successful authorization Maverick could access secure memory on the device. Maverick used the hardware JTAG connector and software tools on the host to initiate writing to secure memory. The command completed successfully. Upon finishing the activities, Maverick had to restore the default JTAG access by powering down the device.

Those of ordinary skill in the art will recognize that the present invention has been described in terms of exemplary embodiments based upon use of a JTAG port. However, the invention should not be so limited, since the present invention could be implemented using other access ports. For example, both standards-based ports and custom ports may be integrated with an access manager and a level controller to form a protected access port.

Certain elements of the present invention, as described in embodiments herein, are implemented using a programmed processor executing programming instructions that are broadly described above in sequential diagram and state diagram form that can be stored on any suitable electronic storage medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the spirit and scope of the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for controlling access by a user to an embedded device comprising:
detecting an authorization request from a user device to be granted access to the embedded device at a requested protection level;
issuing a challenge phrase and a device identifier to the user device in response to the authorization request;
verifying the user device's response to the challenge phrase; and
granting the user device access to the embedded device at the requested protection level if authorization of the user device's response is successful.

2. A method in accordance with claim 1, further comprising:
generating a random number; and
combining the random number and the requested protection level information to produce the challenge phrase.

3. A method in accordance with claim 2, wherein the user device's response comprises a verification token that includes the random number and wherein verifying the user device's response to the challenge phrase comprises comparing the verification token with the random number used to form the challenge phrase.

4. A method in accordance with claim 1, wherein granting the user device access to the embedded device at the requested protection level comprises configuring a protected JTAG port at the requested protection level.

5. A method for a user device to access an embedded device comprising:
issuing an authorization request to the embedded device to be authorized to access at a requested protection level;
receiving a challenge phrase and a device identifier from the embedded device;
passing the challenge phrase, the device identifier and credentials of the user device to a secure server;
receiving a response from the secure server; and
passing the response to the embedded device for verification.

6. A method in accordance with claim 5, wherein the device identifier is embedded in the challenge phrase.

7. A method in accordance with claim 5, further comprising forming a trusted connection with the secure server.

8. A method in accordance with claim 5, further comprising access the embedded processor via a protected JTAG port of the embedded device.

9. A protected port for controlling access by a user device to an embedded device, the protected port comprising:
a port controller operable to interface with the user device;
an access manager operable to determine if the user device is authorized for access at a requested protection level;
an access port; and
a level controller responsive to the access manager and operable to control a protection level of the access port,
wherein the access port is supported by an architecture specific hardware and provides limitation of access to the embedded device.

10. A protected port in accordance with claim 9, wherein the access port comprises a communication access port.

11. A protected port in accordance with claim 9, wherein the access manager comprises:
a random number generator operable to generate a random number in response to a request from the user device to be authorized to access the embedded device at a requested protection level; and
a verification module operable to determine the veracity of a response by the user device to the challenge phrase.

12. A protected port in accordance with claim 11, wherein the verification module is operable to encrypt the random number and level into a challenge phrase using a public key corresponding to a private key of the embedded device stored on a secure server and operable to verify response.

13. A protected port in accordance with claim 9, wherein the level controller is operable to configure the access port at a protection level determined by the access manager and a fuse mechanism.

14. A protected port in accordance with claim 9, wherein the request protection level is selected from the group consisting of unprotected, low protection, high protection, gated high protection and maximum protection.

15. A protected port in accordance with claim 9, further comprising a fuse mechanism operable to prevent the user device from decreasing the protection level without authorization.

16. A protected port in accordance with claim 9, wherein electrical connections between the access manager, the level controller and the access port are formed on an internal silicon layer of the embedded device.

17. A system for controlling access by a user device to an embedded device, the system comprising:
a protected access port integral with the embedded device and comprising a access manager operable to issue a challenge phrase in response to a request sequence from the user device to access the embedded device and further operable to determine the veracity of a response by the user device to the challenge phrase;
a secure server operable to store a private key of the embedded device corresponding to the public key of the embedded device; and
port access equipment operable by the user device to pass the challenge phrase and user credentials to the secure connection with the secure server;
wherein the secure server is further operable to authenticate the user credentials and issue the response to the challenge phrase dependent upon the private key of the embedded device, and wherein the challenge phrase comprises a cipher of the random number combined with the request sequence.

18. A system in accordance with claim 17, wherein the protected access port is a protected JTAG port.

19. An apparatus for controlling access by a user to an embedded device via a protected port comprising:
a challenge means for issuing a challenge phrase to a user device;
a authorization means for verifying a response by the user device to the challenge phrase to determine if the user is authorized for access at a requested protection level; and
a level control means, responsive to the verification means, for selecting an access mode of the protected port.

20. An apparatus in accordance with claim 19, wherein the challenge means is operable to form a challenge phrase comprising:
a cipher of a random number combined with request sequence encoded with a public key; and
an identifier of the embedded device.

21. An apparatus in accordance with claim 19, wherein the authorization means is operable to compare the response by the user device to a random number used to compose the challenge phrase.

22. An apparatus in accordance with claim 19, wherein the authorization means is operable to compare the response by the user device to an arithmetic modification of a random number used to compose the challenge phrase.

23. An apparatus in accordance with claim 19, wherein the protected port comprises a JTAG port.
